(19) United States
(12) Patent Application Publication
(10) Pub. No.: US 2011/0106548 A1
(43) Pub. Date: May 5, 2011

(54) COMPENSATION DISCRIMINATION DETECTOR

(75) Inventors: TY HAYDEN, Grand Junction, CO (US); Anadi UPADHYAYA, Kondapur (IN); Alex DREXEL, Los Gatos, CA (US)

(73) Assignee: ORACLE INTERNATIONAL CORPORATION, Redwood Shores, CA (US)

(21) Appl. No.: 12/608,090

(22) Filed: Oct. 29, 2009

(51) Int. Cl. G06Q 10/00

(52) U.S. Cl. 705/1.1

(57) ABSTRACT

One embodiment of the invention includes a computer-implemented method for detecting compensation discrimination. The method includes determining compensation for an employee in a protected class, and determining median compensation for all comparable employees to the employee in the protected class. The method may then further include analyzing the compensation and the median compensation to determine whether there is a compensation differential that demonstrates discrimination in the compensation for the employee in the protected class.

### FIELD

Embodiments of the invention are generally related to computer systems and, in particular, employee compensation computer systems.

### BACKGROUND

Pay discrimination based on age, disability, national origin, pregnancy, race, veteran status, religion, sex, or any other protected class has serious consequences for an organization. In particular, compensation discrimination can render an organization vulnerable to costly legal action and have a negative impact on the workforce, sales, and profit.

Further, compensation discrimination in employment is prohibited by the Equal Pay Act of 1963, Title VII of the Civil Rights Act of 1964, the Age Discrimination in Employment Act of 1967 (ADEA), and Title I of the Americans with Disabilities Act of 1990 (ADA). These statutes are enforced by the U.S. Equal Employment Opportunity Commission (EEOC). Collectively, the statutes require employers to compensate employees without regard to race, religion, sex, national origin, age, disability or protected condition. The law against compensation discrimination includes all payments made to employees as remuneration for employment. All forms of compensation are covered including, for instance, salary, overtime pay, bonuses, stock options, profit sharing and bonus plans, life insurance, vacation and holiday pay, cleaning or gasoline allowances, hotel accommodations, reimbursement for travel expenses, and benefits. The EEOC encourages all employers to evaluate their compensation systems to ensure that the compensation of employees is based on nondiscriminatory factors.

The Equal Pay Act (EPA) requires that men and women be given equal pay for equal work in the same establishment. The jobs need not be identical, but they must be substantially equal. It is job content, not job titles, that determines whether jobs are substantially equal. Jobs are considered substantially equal if they require substantially equal skill, effort and responsibility, and are performed under similar working conditions within the same establishment. Under the EPA, a gender-based compensation difference in substantially equal jobs is justified only if it is based on: a seniority system, a merit system, a system which measures earnings by quantity or quality of production (“incentive system”), or any other factor other than gender. These justifications are known as “affirmative defenses” and it is the employer's burden to prove that they apply. An affirmative defense must explain the entire pay differential. For example, if an employer pays an a woman less than a similarly situated man and claims the differential is due to performance, then a similar pay differential must exist between two men who have the same variance in performance if “performance” is to qualify as an affirmative defense.

In addition, equal wages must be paid in the same form. For example, a male and female who are paid on an hourly basis for substantially equal work must receive the same hourly wage. The employer cannot pay a higher hourly wage to the man and then attempt to equalize the difference by periodically paying a bonus to the woman. Wages include all payments made to (or on behalf of) an employee as remuneration for employment. Wages encompass all forms of compensation, including fringe benefits. Wages include payments that are paid periodically or at a later date, and include salary, overtime pay, bonuses, vacation or holiday pay, cleaning or gasoline allowances, hotel accommodations, use of company car, medical, hospital, accident, life insurance, retirement benefits, stock options, profit sharing, bonus plans, reimbursement for travel expenses, expense accounts, and benefits. Thus, for example, if male and female employees performing substantially equal work receive equal salaries but unequal fringe benefits, an EPA violation may be established.

However, an employer that pays different wages to a male than to a female performing substantially equal work may not violate the EPA if the wage rate is the same. A wage rate is the measure by which an employee's compensation is determined. It encompasses rates of pay calculated on a time, commission, piece, job incentive, profit sharing, bonus, or other basis. For example, if a male and a female employee performing substantially equal sales jobs are paid on the basis of the same commission rate, then a difference in the total commissions earned by the two workers would not violate the Act. Conversely, if the commission rates are different, then a violation could be established even if the total wages paid were the same. The comparable employees need not have held their jobs at the same time. For instance, a violation of the EPA can be established if a male employee is replaced with a lower paid female, or a female employee is replaced with a higher paid male.

Title VII, the ADEA, and the ADA prohibit compensation discrimination on the basis of race, color, religion, sex, national origin, age, disability or protected activity (e.g. pregnancy or veteran status). Unlike the EPA, there is no requirement under Title VII, the ADEA, or the ADA that the claimant's job be substantially equal to that of a higher paid person outside the claimant's protected class, nor do these statutes require the claimant to work in the same establishment as a comparator.

Even if current compensation plans lack prohibited pay discrimination, past discriminatory compensation systems may have lingering discriminatory effects on present salaries. This will be true, for example, if allocations are based on percentages of current salaries which are unfairly differentiated. As a result, if an employer discovers they have a compensation policy or practice that pays minorities lower salaries than other employees, the employer must not only adopt a new non-discriminatory compensation policy, it also must correct salary disparities that began prior to the adoption of the new policy and make the victims whole. In correcting a pay differential, no employee's pay may be reduced. Instead, the pay of the lower paid employee(s) must be increased.

### SUMMARY

In one embodiment, a computer-readable media is provided. The computer-readable media includes instructions stored thereon that, when executed by a processor, causes the processor to function as a compensation discrimination detector. The instructions include determining compensation for an employee in a protected class, determining median compensation for all comparable employees to the employee in the protected class, and analyzing the compensation and the median compensation to determine whether there is a compensation differential that demonstrates discrimination in the compensation for the employee in the protected class.

In another embodiment, a compensation discrimination detector is provided. The compensation discrimination detector includes at least one processor. The at least one processor is configured to cause the compensation discrimination detector to determine compensation for an employee in a protected class, determine median compensation for all comparable employees to the employee in the protected class, and analyze the compensation and the median compensation to determine whether there is a compensation differential that demonstrates discrimination in the compensation for the employee in the protected class.

### BRIEF DESCRIPTION OF THE DRAWINGS

For proper understanding of the invention, reference should be made to the accompanying drawings, wherein:

FIG. 1 illustrates a block diagram of a system that may implement an embodiment of the present invention;

FIG. 2 illustrates a process flow chart according to one embodiment;

FIG. 3 illustrates a user interface according to an embodiment;

FIG. 4 illustrates a user interface according to another embodiment;

FIG. 5 illustrates a user interface according to another embodiment;

FIG. 6 illustrates a user interface according to another embodiment; and

FIG. 7 illustrates a process flow chart according to an embodiment.

### DETAILED DESCRIPTION

Given the importance of compensating all employees without discrimination, employers require a system that allows them to preemptively detect, analyze, and correct any possible compensation discrimination among their employees. Embodiments of the invention provide such a system that would reduce the risk of legal action and/or complaints filed with the EEOC by allowing employers to preemptively detect and avoid such discrimination, and by providing proof to investigators that pay differentials are the result of factors unrelated to the aforementioned protected classes.

Embodiments of the invention provide a compensation discrimination detector that may be used by organizations to help ensure that they are not discriminating on the basis of a protected class, such as race, color, gender, national origin, age, religion, creed, disability, veteran's status, sexual orientation, and/or gender identity or expression, as required by the law. In one embodiment, the compensation discrimination detector determines the compensation for an employee in a protected class, and determines the median compensation for all employees that are similarly situated to the employee in the protected class. The compensation discrimination detector may then analyze the compensation of the employee in the protected class and the median compensation for all of the similarly situated employees in order to determine whether there is a compensation differential that shows a bias in compensation. Additionally, the compensation discrimination detector can provide a non-discrimination report when the analysis does not show bias. According to certain embodiments, the compensation discrimination detector can carry out an automated process that will automatically detect and notify the employer of possible discrimination or bias in any aspect of their compensation plans.

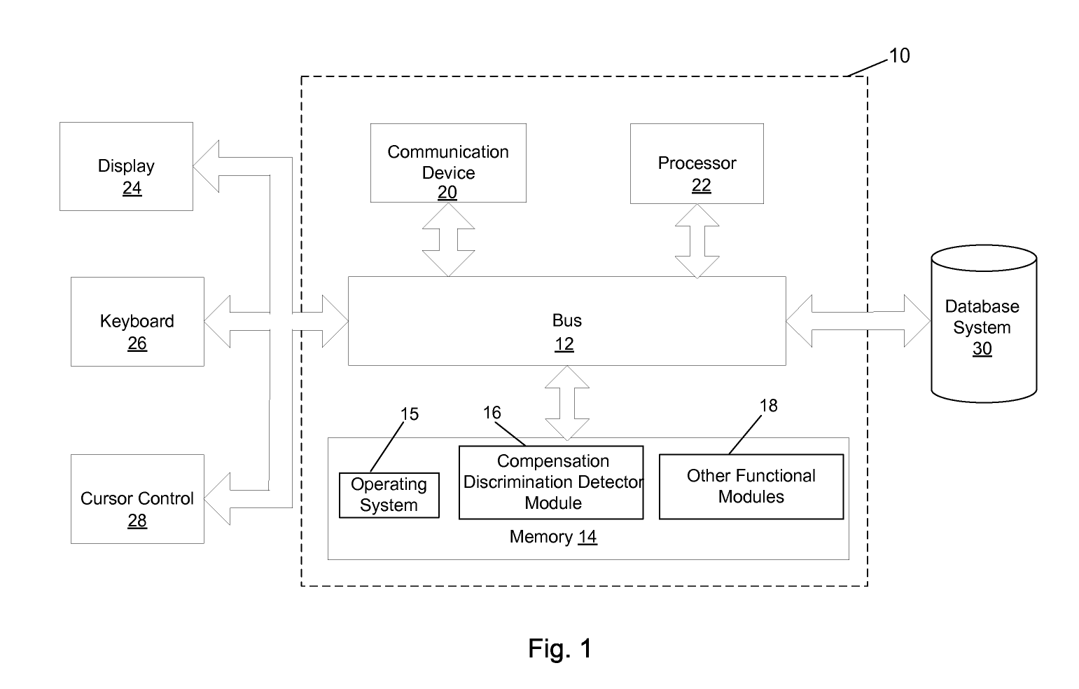

FIG. 1 illustrates a block diagram of a system 10 that may implement one embodiment of the invention. System 10 includes a bus 12 or other communications mechanism for communicating information between components of system 10. System 10 also includes a processor 22, coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer readable media. System 10 further includes a communication device 20, such as a network interface card or other communications interface, to provide access to a network. As a result, a user may interface with system 10 directly or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user, such as configuration information. A keyboard 26 and a cursor control device 28, such as a computer mouse, are further coupled to bus 12 to enable a user to interface with system 10. Processor 22 and memory 14 may also be coupled via bus 12 to a database system 30 and, thus, may be able to access and retrieve information stored in database system 30. Although only a single database is illustrated in FIG. 1, any number of databases may be used in accordance with certain embodiments.

In one embodiment, memory 14 stores software modules that provide functionality when executed by processor 22. The modules may include an operating system 15 that provides operating system functionality for system 10. The memory may also store a compensation discrimination detector module 16, which provides a tool for detecting discrimination in compensation within an organization, as will be discussed in more detail below. System 10 may also include one or more other functional modules 18 to provide additional functionality. For example, functional modules 18 may include a human resource module of an enterprise resource planning (ERP) system. Compensation discrimination detector module 16 may be embedded within the ERP system thereby allowing for ERP system specific validations to be built in.

Database system 30 may include a database server and any type of database, such as a relational or flat file database. Database system 30 may store data related to all employees of an organization, including data related to their compensation, position, experience, performance, and/or any other data required by the compensation discrimination detector module 16, or data associated with system 10 and its associated modules and components.

In certain embodiments, processor 22, compensation discrimination detector module 16, and other functional modules 18 may be implemented as separate physical and logical units or may be implemented in a single physical and logical unit. Furthermore, in some embodiments, processor 22, compensation discrimination detector module 16, and other functional modules 18 may be implemented in hardware, or as any suitable combination of hardware and software.

In some embodiments, compensation discrimination detector module 16 conducts a comparative compensation analysis. The comparative compensation analysis includes identifying employees similarly situated to the employee in a protected class, based on job similarity and other objective factors, and then comparing their compensation. If the employee in the protected class has a compensation that is lower than the compensation of his or her comparator(s), then it is determined whether there is a nondiscriminatory explanation for the differential. The explanation must justify the entire differential in compensation.

Thus, embodiments of the invention provide a mechanism for performing a proactive analysis (i.e., before a complaint is filed) to detect employees who may be unfairly paid based on a protected class. This protects the company's brand, reduces the risk of an EEOC charge, and improves employee engagement. Once an imbalance is detected, the employer can either correct the employee's pay with an equity adjustment or document an affirmative defense for the differential. This will involve comparing every employee of a protected class to their similarly situated peers outside the class. This type of analysis may look at compensation data at an aggregate level and determine if there is a statistical significance in the skewing of compensation data that adversely affects a protected class. In certain embodiments, the determination of whether there are statistically significant compensation disparities after taking into account legitimate factors (education, experience, performance, productivity, location, seniority in the job, time in a particular salary grade, and others) is done by multiple regression.

Threshold statistical tests can tell the employer whether there is a statistically significant difference (i.e., a difference unlikely to have occurred by chance) between the expected and actual number of employees in the protected class who earn less than or equal to the median pay of all comparators. Once the median wage or salary has been determined for similarly situated employees, a comparison is made between the expected and actual number of employees in the protected class whose wages or salaries are at or below the median wage or salary of all comparators. In some embodiments, EEOC codes are used to group similarly situated employees.

According to an embodiment, compensation discrimination detector module 16 can determine whether an employees' protected status has a statistically significant relationship to their compensation even after taking into account other factors that, according to the employer, affect compensation. In one example, the procedure used is a chi square test. Furthermore, a multivariate analysis can be done to show the extent of the relationship between one or more independent factors (e.g., race, length of service, performance rating) and one dependent factor (e.g., compensation).

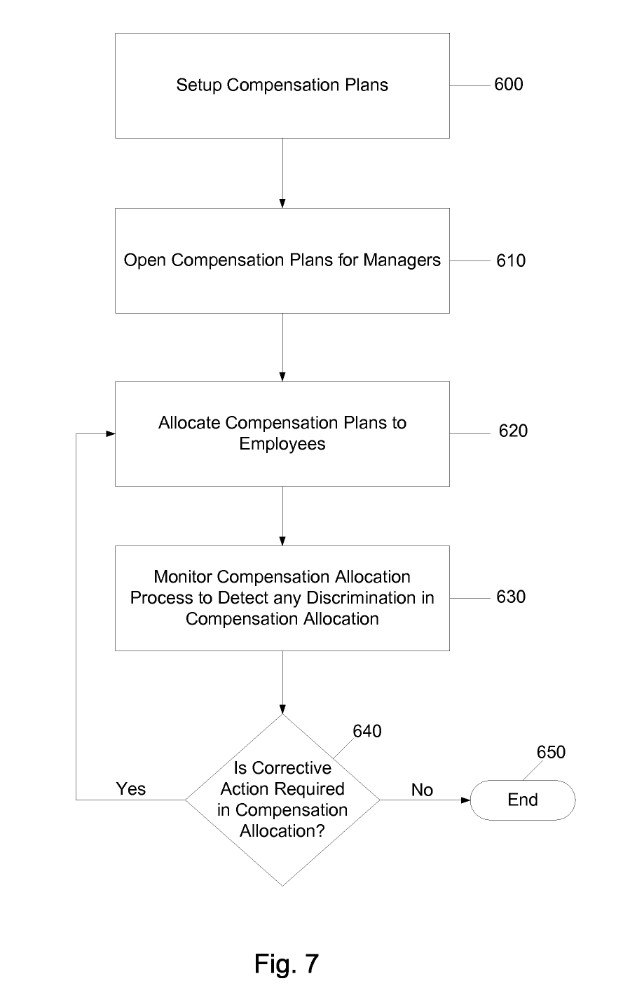

FIG. 7 illustrates a flow diagram of a method for allocating compensation and detecting any discrimination in the compensation according to an embodiment of the invention. At 600, the compensation plans for the organization are setup. At 610, the compensation plans are opened and provided to managers for possible allocation. A compensation plan is then allocated to employees at 620. At 630, the compensation allocation process is monitored to detect any discrimination in the compensation allocation. At 640, it is determined whether corrective action is required in the compensation allocation. If so, then the process returns to 620 where another compensation plan may be allocated to the employee. If, however, it is determined that no corrective action is required with respect to the compensation allocation, then the process ends at 650.

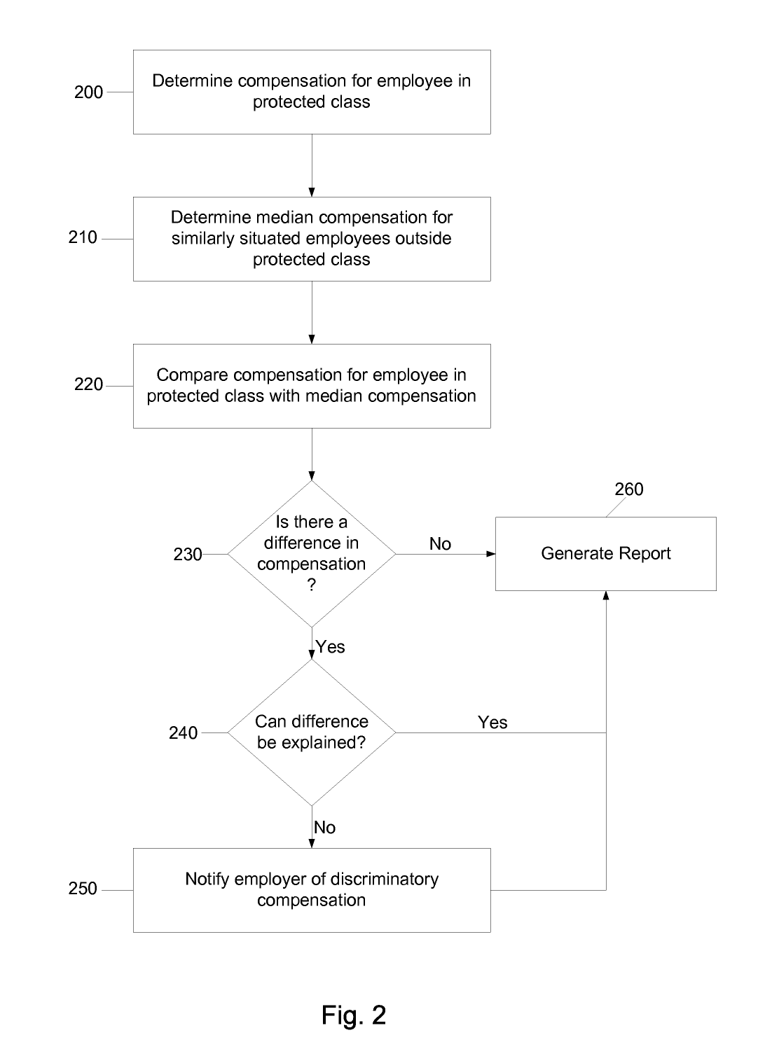

FIG. 2 illustrates a flow diagram of a method for detecting discrimination in employee compensation according to one embodiment. At 200, the compensation for an employee in a protected class, such as a minority, is determined or retrieved. At 210, the median compensation for employees outside the class that are similarly situated to the employee in the protected class is determined. Similarly situated employees may be employees with the same job title, position, responsibilities, etc. as the employee in the protected class. At 220, a comparison is made between the compensation for the employee in the protected class and the median compensation. At 230, it is determined whether there is a difference between the compensations. At 260, a report is generated to detail the results of the analysis. Organizations or employers may utilize the generated report to locate an explanation for any disparities, if any, in compensation between similarly situated employees.

If a difference in compensation is found, then at 240 it is determined whether there is a non-discriminatory explanation for the difference in compensation. If the difference can be explained, then the method proceeds to 260 where a non-discrimination report is generated to document the reasons for the difference in compensation. If there is not a non-discriminatory explanation for the differential in compensation, then at 250 the employer is notified of the possible discrimination in compensation.

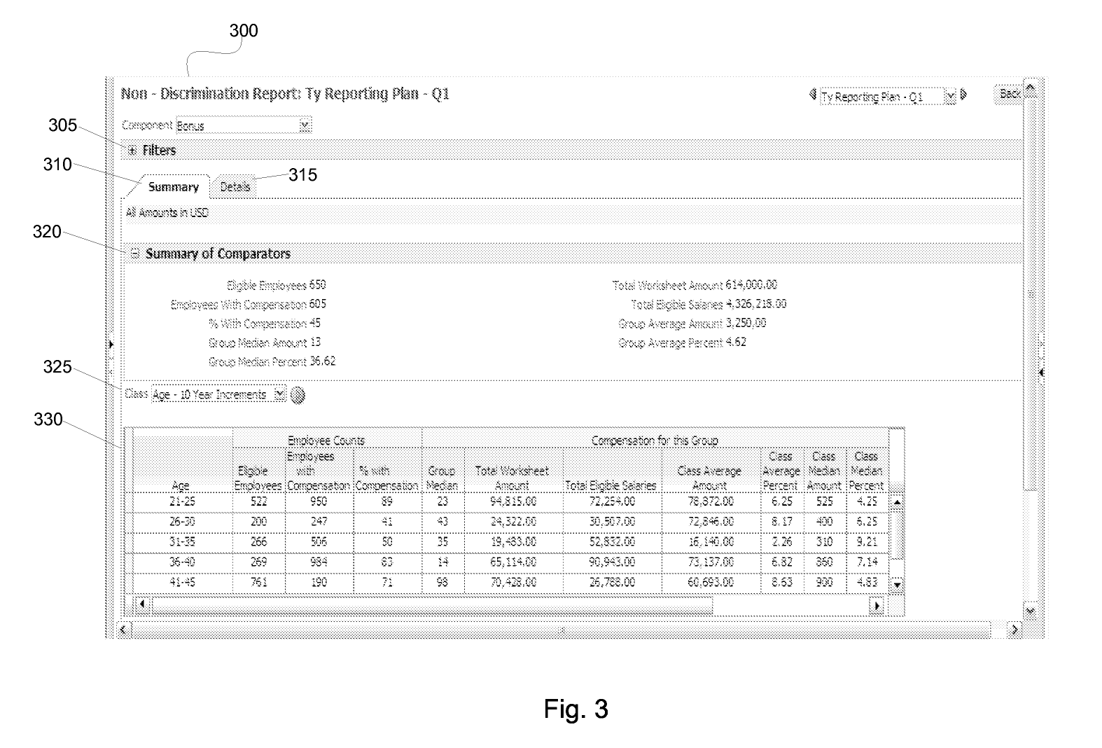

As mentioned above, in certain embodiments, reports are generated to document and summarize the compensation data. As mentioned above, these generated reports include a great deal of information that can be used by employers to identify any instances of discrimination or bias in compensation. FIG. 3 illustrates an example of a non-discrimination report interface 300 that may be utilized to generate a report according to one embodiment. The non-discrimination report interface 300 includes a filters panel 305, a summary panel 310, and a details panel 315. As such, non-discrimination report interface 300 can provide summarized as well as employee level details that will allow for an analysis at the individual level. FIG. 3 illustrates an example summary panel 310 of a report. The summary panel 310 includes a summary of comparators panel 320, and a table 330 that provides certain information for a selected class 325. The summary of comparators panel 320, as shown in FIG. 3, includes information regarding eligible employees, employees with compensation, percent with compensation, group median amount, group median percent, total worksheet amount, total eligible salaries, group average amount, and group average percent.

Table 330 may be divided into sections relating to employee counts, compensation for group, and difference from group average. The employee counts section may include information regarding eligible employees, employees with compensation, and percent with compensation. The compensation for group section may include information regarding group median, total worksheet amount, total eligible salaries, class average amount, class average percent, class median amount, and class median percent. The difference from group average section includes information relating to the amount difference and percent difference. In this example, the selected class 325 is age in ten year increments as shown in the left column of table 330. However, as illustrated in FIG. 6, table 330 may be grouped according to any number of selected class including age in ten year increments, gender, disability, nationality, race, age forty and over, or any other protected class. In other words, FIG. 6 illustrates a discrimination parameter list that may be used to generate a report according to certain embodiments.

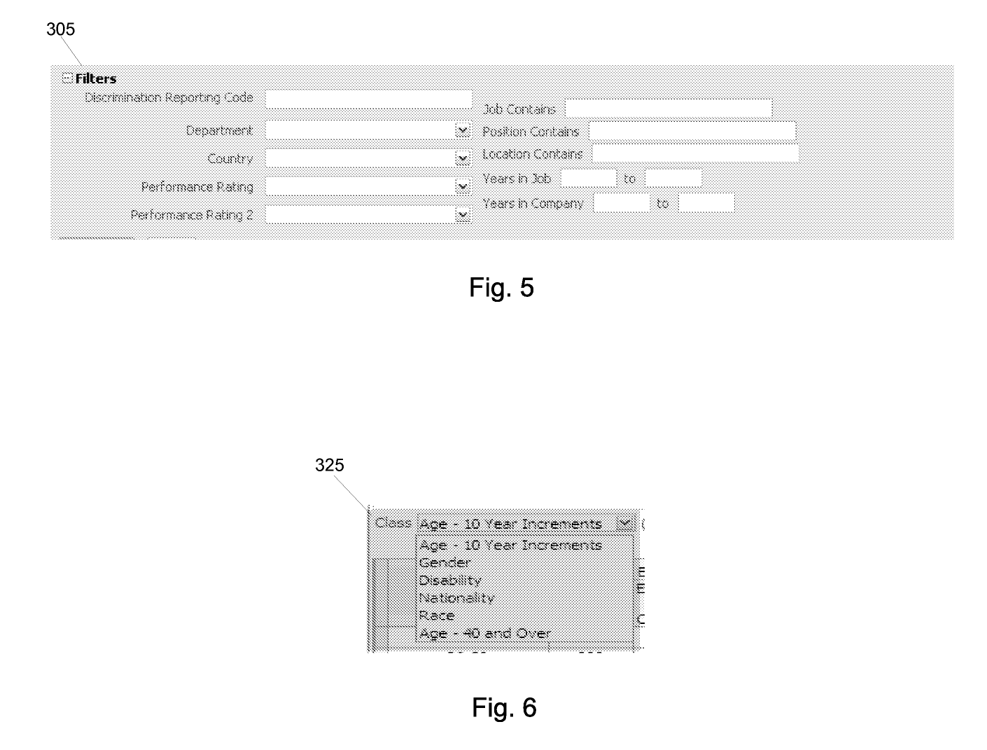

FIG. 5 illustrates an example of the expanded filters panel 305 according to an embodiment. The filters that may be used to filter the results of the report include the discrimination reporting code, department, country, performance rating, job contains, position contains, location contains, years in job, and years in company. Therefore, both the summary and details panels can support data filtering based on these criteria. Employers can use these filters to analyze information such as performance rating and length of service to determine whether there are non-discriminatory reasons (i.e., an affirmative defense) for compensation differentials. As such, according to an embodiment, the generated reports include reduction criteria or filters that can be used to narrow down a group of similarly situated employees in order to more easily identify any discrepancies between them.

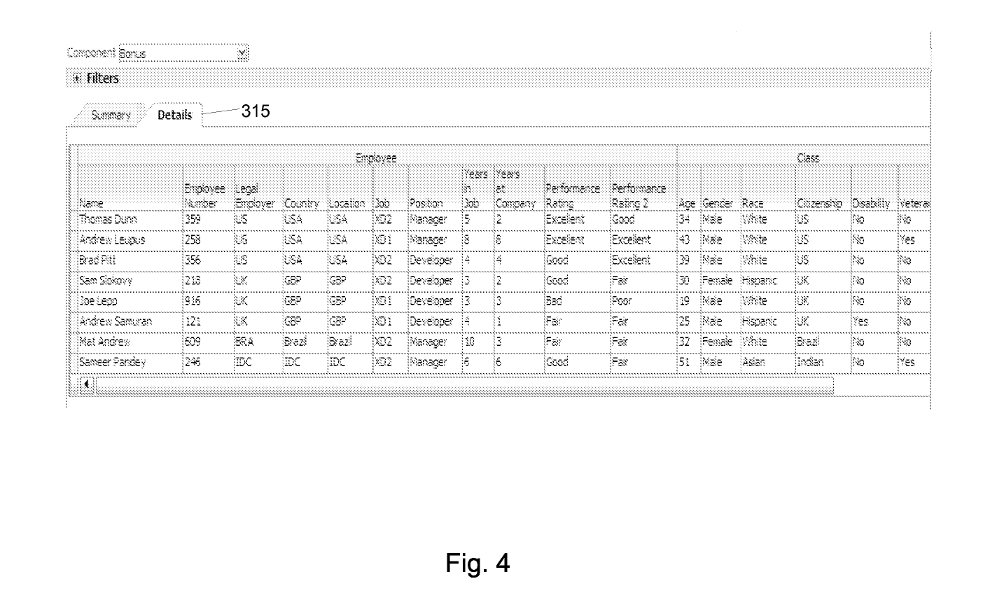

FIG. 4 illustrates an example of the contents of the details panel 315 according to one embodiment. The details panel 315 may include an employee information section, a class section, and a compensation section. The employee information section may include information regarding the employee name, employee number, legal employer, country, location, job, position, years in job, years at company, and performance ratings. The class section may include information regarding age, gender, race, nationality, disability, veteran status, and a discrimination reporting code that may be configurable by the employer. The compensation section includes information relating to an employee's compensation including currency, eligible salary, percent of eligible salary, actual amount, median amount for group, and deviation from median amount. Any generated report, including the summary and details information, can be downloaded into a spreadsheet and can be reference offline.

Further, embodiments of the invention provide a discrimination audit batch job that uses a data mining engine to generate a report that can detect potential cases of compensation differentials that lack affirmative defenses. The discrimination audit batch job may be generated using the various user interfaces described above.

In view of the above, embodiments of the invention provide a compensation discrimination detector and method for detecting discrimination in compensation by comparing the compensation of an employee in a protected class with the median compensation of similarly situated employees. If any differential exists, data relating to the employee can be analyzed to determine whether there are legitimate reasons for the differential, such as performance or experience. The system can be for preventative as well as corrective measures since a discrimination audit batch job can be provided to detect compensation differentials that have yet to be uncovered. Therefore, an employer can perform a proactive analysis to detect employees who may be unfairly compensated as a result of being a member of a protected class thereby ensuring that the employer is not compensating with bias. The compensation discrimination detector can be incorporated into an overall compensation or human resources system and eliminates the need for third party vendor tools. Additionally, the compensation discrimination detector is a global solution that can be customized to comply with the regulations of any country and is, therefore, not country-specific. Further, since the compensation discrimination detector can be embedded in an organization's existing compensation system, taking corrective action when compensation allocation is in progress will be easy and will not require rework thereby saving time and money.

One having ordinary skill in the art will readily understand that the invention as discussed above may be practiced in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable media having instructions stored thereon that, when executed by a processor, causes the processor to function as a compensation discrimination detector, the instructions comprising:
determining compensation for an employee in a protected class;
determining median compensation for all comparable employees to the employee in the protected class; and
analyzing the compensation and the median compensation to determine whether there is a compensation differential that demonstrates discrimination in the compensation for the employee in the protected class.

2. The computer-readable media of claim 1, wherein the analyzing comprises determining whether there is an unwarranted statistical variation between the compensation of the employee in the protected class and the median compensation.

3. The computer-readable media of claim 1, wherein the analyzing comprises:
calculating a difference between the compensation for the employee in the protected class and the median compensation, and
when the compensation for the employee in the protected class is calculated to be lower than the median compensation, determining whether there is a non-discriminatory explanation for the difference.

4. The computer-readable media of claim 3, wherein the non-discriminatory explanation comprises at least one of education, experience, performance, productivity, location, seniority, or amount of time in particular salary grade of the employee in the protected class.

5. The computer-readable media of claim 1, further comprising generating a non-discrimination report when the analysis determines that there is no discrimination in the compensation.

6. The computer-readable media of claim 1, further comprising providing a notification to employer when the analysis determines that there is discrimination in the compensation.

7. The computer-readable media of claim 1, wherein the comparable employees comprise employees with same job title, position, responsibilities, and/or experience level as the employee in the protected class.

8. The computer-readable media of claim 1, further comprising generating a discrimination audit batch job using a data mining engine to detect the compensation differential.

9. A computer-implemented method for detecting compensation discrimination, the method comprising:
determining compensation for an employee in a protected class;
determining median compensation for all comparable employees to the employee in the protected class; and
analyzing the compensation and the median compensation to determine whether there is a compensation differential that demonstrates discrimination in the compensation for the employee in the protected class.

10. The method of claim 9, wherein the analyzing comprises determining whether there is an unwarranted statistical variation between the compensation of the employee in the protected class and the median compensation.

11. The method of claim 9, wherein the analyzing comprises:
calculating a difference between the compensation for the employee in the protected class and the median compensation, and
when the compensation for the employee in the protected class is calculated to be lower than the median compensation, determining whether there is a non-discriminatory explanation for the difference.

12. The method of claim 11, wherein the non-discriminatory explanation comprises at least one of education, experience, performance, productivity, location, seniority, or amount of time in particular salary grade of the employee in the protected class.

13. The method of claim 9, further comprising generating a non-discrimination report when the analysis determines that there is no discrimination in the compensation.

14. The method of claim 9, further comprising providing a notification to employer when the analysis determines that there is discrimination in the compensation.

15. The method of claim 9, further comprising generating a discrimination audit batch job using a data mining engine to detect the compensation differential.

16. A compensation discrimination detector, comprising:
at least one processor,
the at least one processor configured to cause the compensation discrimination detector to
determine compensation for an employee in a protected class;
determine median compensation for all comparable employees to the employee in the protected class; and
analyze the compensation and the median compensation to determine whether there is a compensation differential that demonstrates discrimination in the compensation for the employee in the protected class.

17. The compensation discrimination detector of claim 16, wherein the processor is further configured to analyze the compensation and the median compensation by determining whether there is an unwarranted statistical variation between the compensation of the employee in the protected class and the median compensation.

18. The compensation discrimination detector of claim 16, wherein the processor is configured to analyze the compensation and the median compensation by calculating a difference between the compensation for the employee in the protected class and the median compensation, and
when the compensation for the employee in the protected class is calculated to be lower than the median compensation, determining whether there is a non-discriminatory explanation for the difference.

19. The compensation discrimination detector of claim 18, wherein the non-discriminatory explanation comprises at least one of education, experience, performance, productivity, location, seniority, or amount of time in particular salary grade of the employee in the protected class.

20. The compensation discrimination detector of claim 16, wherein the processor is further configured to generate a non-discrimination report when it is determined that there is no discrimination in the compensation.

21. The compensation discrimination detector of claim 16, wherein the processor is further configured to provide a notification to employer when it is determined that there is discrimination in the compensation.

22. The compensation discrimination detector of claim 9, wherein the processor is further configured to generate a discrimination audit batch job using a data mining engine to detect the compensation differential.
